(19) United States
(12) Patent Application Publication
(10) Pub. No.: US 2014/0051276 A1
(43) Pub. Date: Feb. 20, 2014

(54) WATERPROOF CONNECTOR

(71) Applicant: Tomonari Itou, Yokkaichi-City (JP)

(72) Inventor: Tomonari Itou, Yokkaichi-City (JP)

(73) Assignee: Sumitomo Wiring Systems, Ltd., Yokkaichi-City (JP)

(21) Appl. No.: 14/113,389

(22) PCT Filed: Jan. 6, 2012
(86) PCT No.: PCT/JP2012/050187

§ 371 Date: Oct. 23, 2013

(30) Foreign Application Priority Data
Jun. 28, 2011 (JP) 2011-143401

(51) Int. Cl. H01R 13/52

(52) U.S. Cl. CPC H01R 13/52
USPC 439/271

(57) ABSTRACT

A connector housing (20) has first and second cavities (23), (32) communicating with wire insertion holes (42) of a rubber plug (40) at opposite sides of the wire insertion holes (42) in an extending direction of the wire insertion holes. Terminal fittings (60) are inserted into the first cavities (23) from the second cavities (32) through the wire insertion holes (42). Each terminal fitting (60) has first and second projections (66), (67) spaced apart in the extending direction of the wire insertion holes (42). A distance between projecting ends of the first and second projections (66), (67) exceeds an extension length of the wire insertion holes (42). At least one of the first and second projections (66), (67) constantly contacts the inner peripheral surface of one of the first and second cavities (23), (32) when the terminal fitting (60) is inserted in the wire insertion hole (42).

### BACKGROUND

1. Field of the Invention

This invention relates to a waterproof connector.

2. Description of the Related Art

A conventional waterproof connector is disclosed in Japanese Unexamined Patent Publication No. 2003-22868. This includes a rubber plug, a connector housing and terminal fittings. Each terminal fitting includes a tubular main portion and is connected to an end portion of a wire. A stabilizer is formed to project from the main portion. The rubber plug is formed with a plurality of wire insertion holes extending in forward and backward directions through which wires are insertable. An accommodating portion in which the rubber plug is to be accommodated is formed in the rear surface of the connector housing. Further, the connector housing is formed with first cavities which communicate with the respective wire insertion holes with the rubber plug accommodated in the accommodating portion and extend in forward and backward directions. Further, a holder is mounted on a rear end part of the connector housing after the rubber plug is accommodated into the accommodating portion. The holder is formed with second cavities which communicate with the respective wire insertion holes and extend in forward and backward directions. The terminal fittings are inserted into the first cavities from the second cavities through the wire insertion holes with the rubber plug and the holder assembled with the connector housing. When the terminal fittings are inserted into the first cavities, the outer peripheral surfaces of the wires connected to the terminal fittings are held in close contact with the inner peripheral surfaces of the wire insertion holes, thereby providing sealing around the wires.

In the case of the above conventional waterproof connector, the front or rear end of the terminal fitting inserted into the wire insertion hole is held in the inner peripheral surface of either the first or second cavity and may be inclined with respect to forward and backward directions with this position of contact as a supporting point. If the terminal fitting is inclined in the wire insertion hole, the stabilizer or the like may strongly bite into the inner peripheral surface of the wire insertion hole of the rubber plug and, in a worst-case scenario, the inner peripheral surface of the wire insertion hole may be damaged.

The present invention was completed in view of the above situation and an object thereof is to provide the damage of a rubber plug.

### SUMMARY OF THE INVENTION

To achieve the above object, the invention is directed to a waterproof connector, comprising a rubber plug formed with a wire insertion hole into which a wire is to be inserted. The waterproof connector also has a connector housing formed with an accommodating portion for accommodating the rubber plug and a first cavity and a second cavity communicating with the wire insertion hole at opposite sides of the wire insertion hole in an extending direction of the wire insertion hole in a state where the rubber plug is accommodated in the accommodating portion. A terminal fitting is to be inserted into the first cavity from the second cavity through the wire insertion hole in a state connected to the wire. The outer peripheral surface of the wire is held in close contact with the inner peripheral surface of the wire insertion hole of the rubber plug to provide sealing around the wire with the terminal fitting inserted in the first cavity. The terminal fitting is formed with a first projection and a second projection spaced apart in the extending direction of the wire insertion hole. A distance between projecting ends of the first and second projections is set to be longer than an extension length of the wire insertion hole. At least one of the first and second projections is constantly arranged to come into contact with the inner peripheral surface of either one of the first and second cavities when the terminal fitting is inserted in the wire insertion hole. Thus, the inclination of the terminal fitting in the wire insertion hole is prevented. Therefore, the damage of the rubber plug is avoided.

The terminal fitting preferably includes a main portion in the form of a rectangular tube and the first and second projections are arranged on the same plane of the main portion. As a result, the enlargement of the entire terminal fitting in a projecting direction of the first and second projections is avoided as compared with the case where the first and second projections are arranged on different planes of the main portion. The first and second projections are arranged on the same plane of the main portion of the terminal fitting. Thus, the enlargement of the entire terminal fitting in a projecting direction of the first and second projections is avoided as compared with the case where the first and second projections are arranged on different planes of the main portion.

The connector housing preferably is formed with a first guiding groove and a second guiding groove into which the first and second projections are inserted and fitted and which communicate with the first and second cavities.

The first and second projections preferably are arranged on the same axis extending in an insertion direction into the wire insertion hole. Thus, the first and second guiding grooves of the connector housing can be shared by both the first and second projections so that the configuration of the connector housing can also be simplified.

### BRIEF DESCRIPTION OF THE DRAWINGS

FIG. 1 is a section of a waterproof connector according to one embodiment of the present invention showing a state before terminal fittings are inserted into wire insertion holes of a rubber plug.

FIG. 2 is a section showing a state where leading end parts of the terminal fittings are inserted in the wire insertion holes of the rubber plug.

FIG. 3 is a section showing a state where the terminal fittings are inserted in the wire insertion holes of the rubber plug and the leading end parts thereof project from the wire insertion holes.

FIG. 4 is a section showing a state where the terminal fittings are inserted in first cavities of a connector housing and wires are inserted in the wire insertion holes of the rubber plug.

FIG. 5 is a front view of the connector housing.

### DETAILED DESCRIPTION OF THE PREFERRED EMBODIMENTS

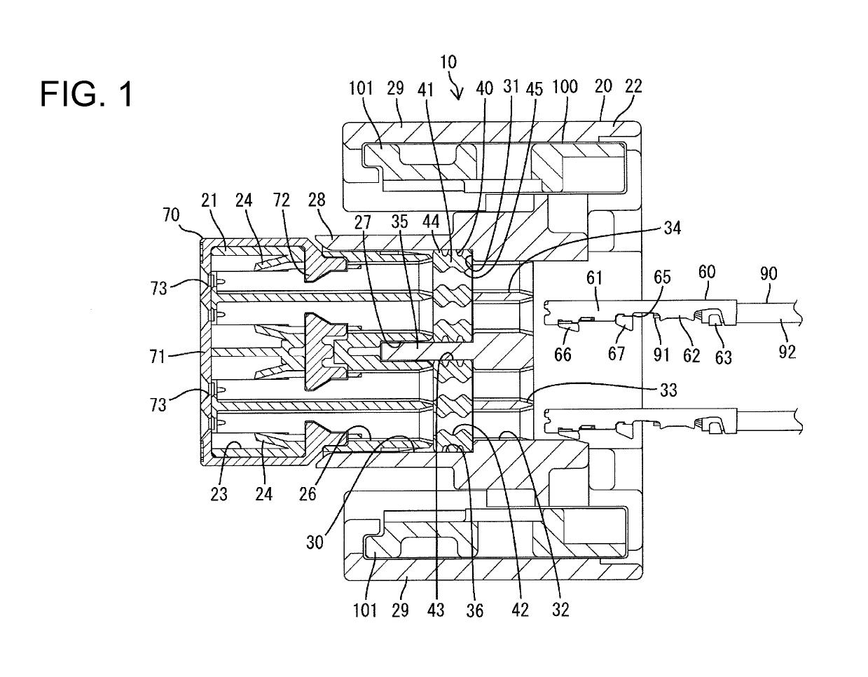

One embodiment of the present invention is described with reference to FIGS. 1 to 5. A waterproof connector 10 according to this embodiment includes a connector housing 20, a rubber plug 40 and terminal fittings 60. The connector housing 20 is connectable to an unillustrated mating connector housing. Note that, in the following description, a side to be connected to the mating connector housing is referred to as a front side concerning forward and backward directions.

The connector housing 20 is made of synthetic resin and, as shown in FIG. 1, includes an inner housing 21 and an outer housing 22. The inner housing 21 is in the form of a block and the outer housing 22 is in the form of a tube surrounding the inner housing 21. The inner housing 21 and the outer housing 22 are detachably coupled to each other.

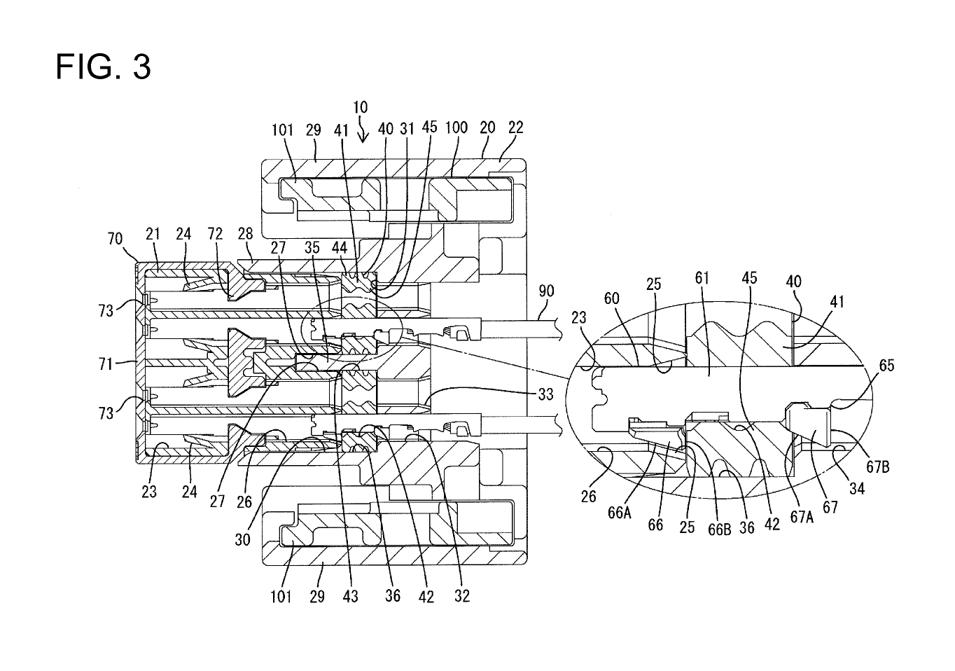

As shown in FIG. 1, a plurality of first cavities 23 are formed in the inner housing 21 to extend in forward and backward directions. A resiliently deformable locking lance 24 is formed to project forward at the inner surface of each first cavity 23. In the case of this embodiment, the respective first cavities 23 are arranged in four vertical levels and the respective locking lances 24 are substantially vertically symmetrically arranged with respect to an axis between the first cavities 23 in the second and third levels. As shown in FIG. 3, a first inclined portion 25 which is gradually widened toward the rear surface of the inner housing 21 is formed at a rear end part of each first cavity 23. Further, a first guiding groove 26 into which first and second projections 66, 67 to be described later are slidably inserted is formed to extend in forward and backward directions in the inner surface of each first cavity 23. The rear end of the first guiding groove 26 is open on the rear surface of the inner housing 21. Further, a fitting recess 27 is formed in a substantially vertically central part of the rear surface of the inner housing 21. The fitting recess 27 is formed by cutting a partition wall partitioning between the first cavities 23 in the second and third levels.

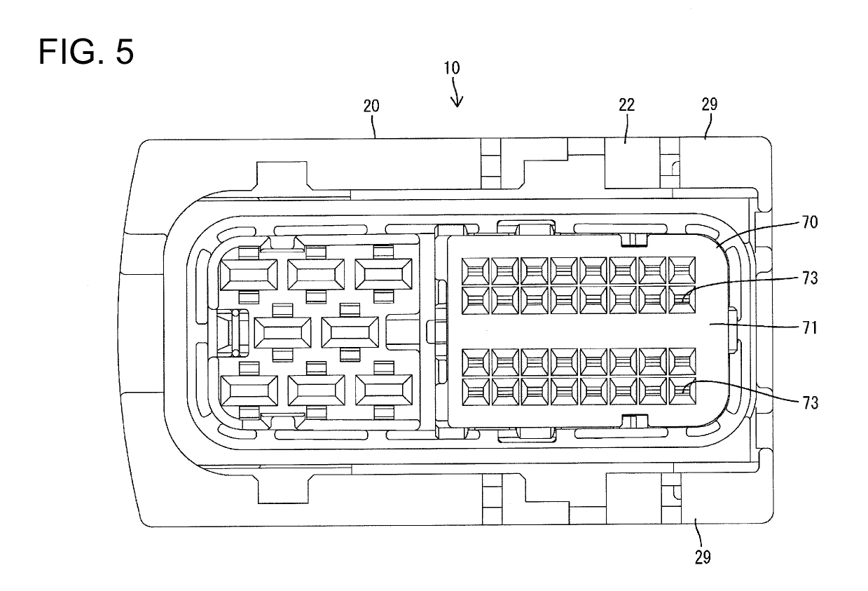

A front mask 70 made of synthetic resin is mounted into the inner housing 21. The front mask 70 includes a front wall 71 for covering the front surface of the inner housing 21 and retaining portions 72 to be inserted into the inner housing 21 and is movable in a width direction (direction perpendicular to forward and backward directions). As shown in FIG. 5, a plurality of tab insertion holes 73 which define the front openings of the first cavities 23 are formed in the front wall 71. When the connector housing 20 is connected to the mating connector housing, male tabs mounted in the mating connector housing are inserted into the first cavities 23 through the tab insertion holes 73 from front and electrically connected to the terminal fittings 60 in the first cavities 23. When the front mask 70 is properly mounted into the inner housing 21, the respective retaining portions 72 are arranged to be able to lock the terminal fittings 60 from behind.

As shown in FIG. 1, the outer housing 22 includes a tubular outer main body 28 covering a range from the rear surface to a substantially rear half of the outer peripheral surface of the inner housing 21 and a pair of slider accommodating portions 29 integrally connected to both upper and lower ends of the outer main body 28. Operating plates 101 of a slider 100 are movably accommodated in the both slider accommodating portions 29. A force is multiplied between the both operating plates 101 and the mating connector housing due to a movement of the slider 100, so that the connector housing 20 is connected with a small operation force.

A connection space 30 in which a substantially rear half of the inner housing 21 and the rubber plug 40 can be accommodated is formed to be open forward in the outer main body 28. As shown in FIG. 1, a step 31 which comes into contact with the rear end of the rubber plug 40 to retain the rubber plug 40 is formed on the front surface of the outer main body 28 which serves as the back wall of the connection space 30. A plurality of second cavities 32 are formed to extend in forward and backward directions at positions corresponding to the respective first cavities 23 in the outer main body 28. The respective second cavities 32 have substantially the same shape and same diameter as the respective first cavities 23. A second inclined portion 33 which is gradually widened toward the rear surface of the outer main body 28 is formed at a rear end part of each second cavity 32. Further, the second cavity 32 is formed with a second guiding groove 34, into which the first and second projections 66, 67 are slidably inserted, at a position on the same axis extending in forward and backward directions as the first guiding groove 26 of the first cavity 23. The second guiding groove 34 extends over the entire length of the second cavity 32 and both front and rear ends of the second guiding groove 34 are open on both front and rear surfaces of the outer main body 28.

A fitting projection 35 is formed to project forward in a substantially vertically central part of the front surface of the outer main body 28. When the outer housing 22 is assembled with the inner housing 21, the fitting projection 35 is inserted and fitted into the fitting recess 27.

Further, as shown in FIG. 1, the connector housing 20 is formed with an accommodating portion 36, into which the rubber plug 40 can be fitted and accommodated, between the rear surface of the inner housing 21 and the front surface of the outer housing 22. In that case, the rubber plug 40 is arranged to be sandwiched between the inner housing 21 and the outer housing 22 in forward and backward directions in the accommodating portion 36.

The rubber plug 40 is made of rubber such as silicon rubber and, as shown in FIG. 1, includes a rubber plug main body 41 in the form of a flat block short in forward and backward directions. The rubber plug main body 41 is formed with a plurality of wire insertion holes 42 extending in forward and backward directions at positions corresponding to the first and second cavities 23, 32. Further, a through hole 43 is formed in parallel to the respective wire insertion holes 42 at a position corresponding to the fitting projection 35 substantially in a central part of the rubber plug main body 41.

A plurality of outer peripheral lips 44 are formed side by side in forward and backward directions on the outer peripheral surface of the rubber plug main body 41. Further, a plurality of inner peripheral lips 45 are formed side by side in forward and backward directions on the inner peripheral surfaces of the respective wire insertion holes 42 and the through hole 43 in the rubber plug main body 41. Diameters of the inner ends of the inner peripheral lips 45 are set to be smaller than diameters of the first and second cavities 23, 32. In the case of this embodiment, three inner peripheral lips 45 and three outer peripheral lips 44 of the through hole 43 are arranged one after another in forward and backward directions at the same phases, and two inner peripheral lips 45 of the wire insertion hole 42 are arranged one after the other in forward and backward directions.

The terminal fitting 60 is inserted into the first cavity 23 of the inner housing 21 from the second cavity 32 of the outer housing 22 through the wire insertion hole 42 of the rubber plug 40 and held and retained by the locking lance 24 and the retaining portion 72. Specifically, the terminal fitting 60 is integrally formed, such as by bending an electrically conductive metal plate and, as shown in FIG. 1, includes a main portion 61 in the form of a rectangular tube and a barrel portion 62, 63 integrally connected behind the main portion 61. The barrel portion 62, 63 is composed of a wire barrel 62 to be crimped and connected to a core 91 exposed at an end portion of a wire 90 and an insulation barrel 63 located behind the wire barrel 62 and to be crimped and connected to an insulation coating 92 at the end portion of the wire 90. The male tab is inserted into the main portion 61 from front to be electrically connected as the both connector housings are connected. Further, the rear end edge of the main portion 61 serves as a locking edge 65 to be locked by the retaining portion 72 and is arranged to extend in a vertical direction.

Four surfaces (opposite side surfaces, lower surface and upper surface) forming the outer wall surface of the main portion 61 are positioned to be substantially perpendicular to each other and each of them is arranged substantially along the same plane. The first and second projections 66, 67 are formed to project from the lower surface of the main portion 61 while being spaced part in forward and backward directions. The first and second projections 66, 67 are formed by bending the lower wall of the main portion 61. The front surfaces of the first and second projection 66, 67 are inclined surfaces 66A, 67A inclined backward, and the rear surfaces thereof are vertical surfaces 66B, 67B extending substantially in the vertical direction.

The first projection 66 is arranged substantially in a widthwise central part of a front end part of the main portion 61, and the second projection 67 is arranged substantially in a widthwise central part of a rear end part of the main portion 61. The first and second projections 66, 67 are arranged in parallel while being spaced apart on the same axis extending in forward and backward directions. With the terminal fitting 60 properly inserted in the first cavity 23, the locking lance 24 is arranged between the first and second projections 66, 67 and the locking lance 24 is engageable with the first projection 66 from behind.

Projecting ends of the first and second projections 66, 67 are arranged substantially at the same height position. Further, the vertical surface 66B, 67B of the second projection 67 is arranged to be substantially continuous and flush with the locking edge 65.

Here, a distance (spacing in forward and backward directions) between the projecting ends of the first and second projections 66, 67 is set to be slightly longer than an extension length of the wire insertion holes 42, i.e. the length of the rubber plug 40 in forward and backward directions (thickness in forward and backward directions). Thus, while the terminal fitting 60 is passing through the wire insertion hole 42, the first and second projections 66, 67 are arranged at opposite sides across the rubber plug 40.

Next, an operation of accommodating the terminal fitting 60 into the connector housing 20 in the waterproof connector 10 according to this embodiment is described.

First, the rubber plug 40 is inserted into the connection space 30 of the outer main body 28 of the outer housing 22. At this time, the fitting projection 35 is fitted into the through hole 43 of the rubber plug 40, whereby the rubber plug 40 is positioned and held in contact with the front surface of the outer main body 28. Subsequently, the inner housing 21 is inserted into the outer main body 28 from front and the inner housing 21 and the outer housing 22 are locked to each other. At this time, the rubber plug 40 is tightly held in the accommodating portion 36 formed between the rear surface of the inner housing 21 and the front surface of the outer main body 28.

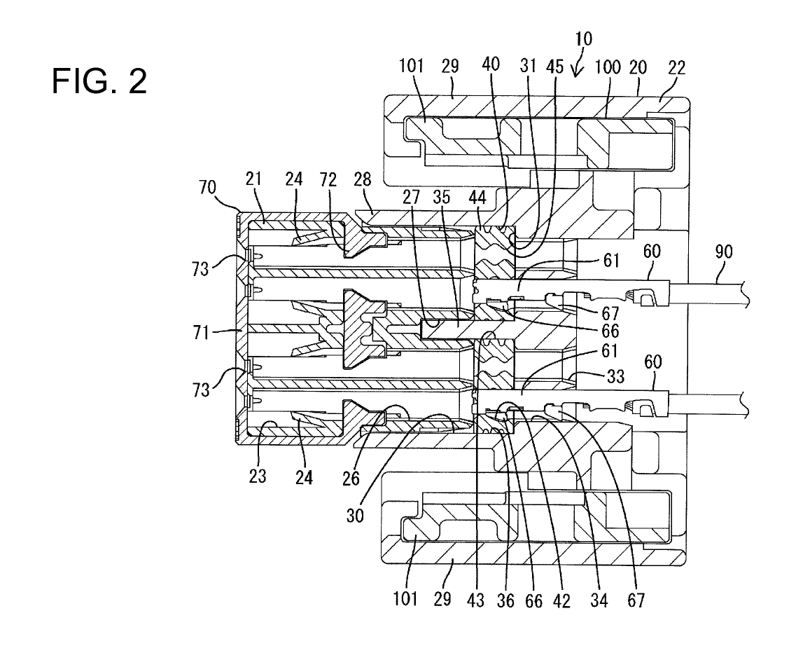

Subsequently, as shown in FIGS. 1 and 2, the terminal fitting 60 connected to the wire 90 is inserted into the first cavity 23 of the inner housing 21 from behind. If the terminal fitting 60 is in a vertically inverted posture, the first projection 66 interferes with the rear surface of the outer main body 28 without being inserted into the second guiding groove 34, thereby preventing an inserting movement of the terminal fitting 60. Thus, erroneous insertion of the terminal fitting 60 is prevented.

At an initial stage of the insertion of the terminal fitting 60, the main portion 61 slides on the second inclined portion of the second cavity 32, whereby the terminal fitting 60 is smoothly inserted into the second cavity 32. When a leading end part of the main portion 61 is inserted into the wire insertion hole 42 of the rubber plug 40 through the second cavity 32 of the outer housing 22, the inclined surface 66A, 67A of the first projection 66 slides on the inner peripheral lip 45 and the wire insertion hole 42 is gradually widened. In a state where the projecting end (leading end) of the first projection 66 is in contact with the lower end of the inner peripheral surface of the wire insertion hole 42 as shown in FIG. 2, the projecting end of the second projection 67 is arranged to be able to come into contact with the groove bottom of the second guiding groove 34 in the inner peripheral surface of the second cavity 32. In this way, the first and second projections 66, 67 are supported at two positions spaced apart in forward and backward directions, whereby the oblique inclination of the main portion 61 with respect to forward and backward directions is prevented and the terminal fitting 60 is inserted straight.

When the terminal fitting 60 is further inserted and the leading end part of the main portion 61 enters the first cavity 23 as shown in FIG. 3, the first projection 66 is arranged to be able to come into contact with the first inclined portion 25, the second projection 67 is arranged to be able to come into contact with the groove bottom of the second guiding groove 34 in the inner peripheral surface of the second cavity 32 and an area between the first and second projections 66, 67 on the main portion 61 is resiliently held in close contact with the inner peripheral lips 45 of the wire insertion hole 42. Even if the terminal fitting 60 is vertically shaken at this time, either one of the first and second projections 66, 67 comes into contact with the corresponding wall surface, thereby preventing the terminal fitting 60 from being inclined with respect to forward and backward directions. Further, the main portion 61 is smoothly inserted into the first cavity 23 due to the first inclined portion 25.

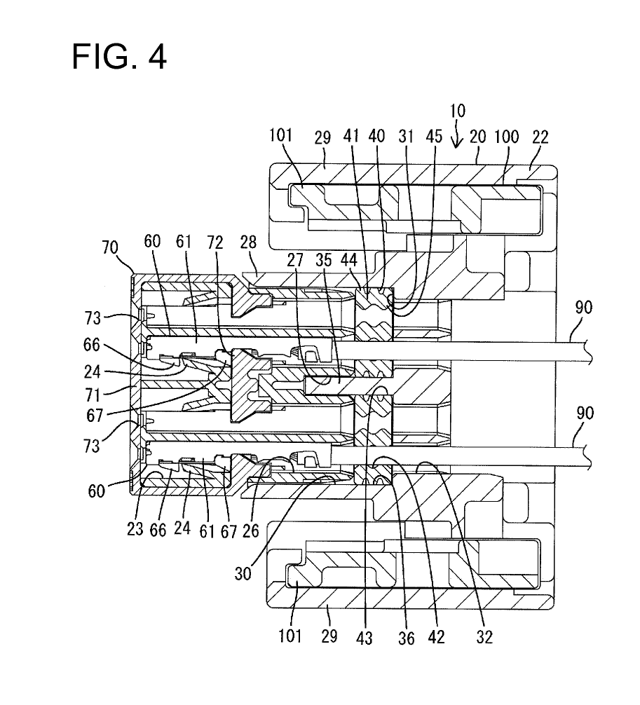

When the terminal fitting 60 is further inserted, the first projection 66 is arranged to be able to come into contact with the groove bottom of the first guiding groove 26 in the inner peripheral surface of the first cavity 23 and the second projection 67 is arranged in contact with the lower end of the inner peripheral surface of the wire insertion hole 42. When the entire main portion 61 is inserted into the first cavity 23, both the first and second projections 66, 67 are arranged to be able to come into contact with the groove bottom of the first guiding groove 26 in the inner peripheral surface of the first cavity 23. Thereafter, even when the terminal fitting 60 is inserted to a proper depth into the first cavity 23 as shown in FIG. 4, the first and second projections 66, 67 are kept in a state where they can come into contact with the groove bottom of the first guiding groove 26. Thus, in a state where the terminal fitting 60 is inserted in the wire insertion hole 42, at least one of the first and second projections 66, 67 is constantly in contact with the inner peripheral surface of either one of the first and second cavities 23, 32. As a result, the terminal fitting 60 is kept in a proper inserting posture by the first and second projections 66, 67 being supported.

Note that when the terminal fitting 60 is inserted to the proper depth into the first cavity 23, the inner peripheral lips 45 of the wire insertion hole 42 are resiliently held in close contact with the outer peripheral surface of the wire 90, thereby providing sealing around the wire 90. Further, the outer peripheral lips 44 of the rubber plug 40 are resiliently held in close contact with the inner peripheral surface of the accommodating portion 36 (outer main body 28), thereby also providing sealing in the connector housing 20. A leading end part of the locking lance 24 is arranged to be able to lock the vertical surface 66B, 67B of the first projection 66 from behind and the retaining portion 72 of the front mask 70 is arranged to be able to lock the vertical surface 66B, 67B of the second projection 67 from behind, whereby the terminal fitting 60 is held and retained in the first cavity 23.

As described above, according to this embodiment, the first and second projections 66, 67 are formed on the terminal fitting 60 while being spaced apart in forward and backward directions, the distance between the projecting ends of the first and second projections 66, 67 is set to be longer than the extension length of the wire insertion hole 42, and at least one of the first and second projections 66, 67 comes into contact with the inner peripheral surface of either one of the first and second cavities 23, 32 in the process of inserting the terminal fitting 60 into the wire insertion hole 42. Thus, the inclination of the terminal fitting 60 in the wire insertion hole 42 is prevented. Therefore, the damage of the inner peripheral surface (inner peripheral lips 45) of the wire insertion hole 42 due to the inclination of the terminal fitting 60 is avoided.

Further, since the first and second projections 66, 67 are arranged on the same plane of the main portion 61 of the terminal fitting 60, the enlargement of the entire terminal fitting 60 in a projecting direction of the first and second projections 66, 67 is avoided as compared with the case where the first and second projections 66, 67 are arranged on different planes.

Furthermore, since the first and second projections 66, 67 have both a function of guiding the inserting movement of the terminal fitting 60 by being inserted into the first and second guiding grooves 26, 34 and a function of preventing the inclination of the terminal fitting 60, the entire configuration can be simplified as compared with the case where the both functions are separately formed. In addition, since the first and second projections 66, 67 are arranged on the same axis extending in an insertion direction into the wire insertion hole 42, the first and second guiding grooves 26, 34 of the connector housing 20 can be shared by both the first and second projections 66, 67. Therefore, the configuration of the connector housing 20 can also be simplified.

The present invention is not limited to the above described and illustrated embodiment. For example, the following embodiments are also included in the technical scope of the present invention.

The connector housing may be composed of a housing main body and a holder, first cavities may be formed in the housing main body, second cavities may be formed in the holder, an accommodating recess may be formed in the rear surface of the housing main body, and the holder may be assembled with the housing main body from behind with a rubber plug accommodated in the accommodating recess, thereby holding and retaining the rubber plug in the accommodating recess.

The first and second projections may not have the function of guiding the terminal fitting by not being inserted into the first and second guiding grooves of the connector housing.

1. A waterproof connector, comprising:
a rubber plug formed with a wire insertion hole into which a wire is to be inserted;
a connector housing formed with an accommodating portion for accommodating the rubber plug and a first cavity and a second cavity communicating with the wire insertion hole at opposite sides of the wire insertion hole in an extending direction of the wire insertion hole in a state where the rubber plug is accommodated in the accommodating portion; and
a terminal fitting to be inserted into the first cavity from the second cavity through the wire insertion hole in a state connected to the wire;
the outer peripheral surface of the wire being held in close contact with the inner peripheral surface of the wire insertion hole of the rubber plug to provide sealing around the wire with the terminal fitting inserted in the first cavity;
wherein the terminal fitting is formed with a first projection and a second projection spaced apart in the extending direction of the wire insertion hole, a distance between projecting ends of the first and second projections is set to be longer than an extension length of the wire insertion hole, and at least one of the first and second projections is constantly arranged to come into contact with the inner peripheral surface of either one of the first and second cavities in a state where the terminal fitting is inserted in the wire insertion hole.

2. The waterproof connector of claim 1, wherein the terminal fitting includes a main portion in the form of a rectangular tube and the first and second projections are arranged on the same plane of the main portion.

3. The waterproof connector of claim 2, wherein the connector housing is formed with a first guiding groove and a second guiding groove into which the first and second projections are inserted and fitted and which communicate with the first and second cavities.

4. The waterproof connector of claim 3, wherein the first and second projections are arranged on the same axis extending in an insertion direction into the wire insertion hole.

5. The waterproof connector of claim 1, wherein the connector housing is formed with a first guiding groove and a second guiding groove into which the first and second projections are inserted and fitted and which communicate with the first and second cavities.

6. The waterproof connector of claim 5, wherein the first and second projections are arranged on the same axis extending in an insertion direction into the wire insertion hole.
